(19) United States
(12) Patent Application Publication
(10) Pub. No.: US 2025/0246763 A1
(43) Pub. Date: Jul. 31, 2025

(54) BUSBAR INTERCONNECT FOR A BATTERY PACK

(71) Applicant: TE Connectivity Solutions GmbH, Schaffhausen (CH)

(72) Inventors: Evan Dawley, Troy, MI (US); Raghunandan S. Shanbhag, Bangalore (IN); Andre Martin Dressel, Bensheim (DE); Craig Kennedy, Fremont, CA (US)

(21) Appl. No.: 18/667,019

(22) Filed: May 17, 2024

(30) Foreign Application Priority Data
Jan. 25, 2024 (IN) 202441005119

(51) Int. Cl. H01M 50/507; H01M 50/218; H01M 50/233; H01M 50/51

(52) U.S. Cl. CPC H01M 50/507; H01M 50/218; H01M 50/233; H01M 50/51

(57) ABSTRACT

A busbar interconnect for electrically connecting cell terminals of battery cells in a battery pack includes a plurality of busbars arranged in an array having multiple rows and multiple columns of the busbars. Each busbar includes a first mating end for mating with the corresponding cell terminal of the corresponding battery cell and a second mating end for mating with the adjacent cell terminal of the adjacent corresponding battery cell. The busbars electrically connect the battery cells in the battery pack. The busbar interconnect includes a busbar carrier holding each of busbars in the array. The busbar carrier includes frame members holding relative positions of the busbars. The frame members are structural foam elements.

### CROSS REFERENCE TO RELATED APPLICATIONS

This application claims the benefit of IN application No. 202441005119, filed 25 Jan. 2024, the subject matter of which is herein incorporated by reference in its entirety.

### BACKGROUND OF THE INVENTION

The subject matter herein relates generally to battery packs, such as battery packs for electric vehicles.

Electric vehicles include a battery system including a battery pack having a large number of battery cells. A typical battery system requires a connectivity solution to transfer/distribute power between groups of battery cells and have provisions for sensing battery parameters like voltage and temperature. To transfer power, busbars (aluminum or copper) are usually welded to the cell terminals in serial and/or parallel electrical configuration. As electric vehicle applications proliferate, the overhead cost of components ($/kWh) is scrutinized and there is a desire to minimize costs, such as by minimizing the part count and part numbers. For battery systems of electric vehicles, the battery cell stack sizes are very large. Typically, assembly of the battery system requires many parts, which are individually assembled to the corresponding cell terminals, which is time consuming and adds cost to the assembly process. Some battery systems include an injection molded cover for the battery cells, which holds the busbars. However, as the size of battery packs increase, there are limits to the size of the injection molded cover due to the molding process. For example, the sub-component sizes are too large for conventional injection mold processes. In addition, cycle time requirements (i.e. takt time) must reduce in order to meet greater production volumes. A streamlining of processes wherever possible is greatly needed in order to reduce capital, tooling, and part piece cost and conversion cost. There is also a desire for sustainable processes and supply chain.

A need remains for a method for assembling battery packs, such as for electric vehicles, in a cost effective and reliable manner.

### BRIEF DESCRIPTION OF THE INVENTION

In one embodiment, a busbar interconnect for electrically connecting cell terminals of battery cells in a battery pack is provided. The busbar interconnect includes a plurality of busbars arranged in an array having multiple rows and multiple columns of the busbars. Each busbar includes a first mating end for mating with the corresponding cell terminal of the corresponding battery cell and a second mating end for mating with the adjacent cell terminal of the adjacent corresponding battery cell. The busbars electrically connect the battery cells in the battery pack. The busbar interconnect includes a busbar carrier holding each of busbars in the array. The busbar carrier includes frame members holding relative positions of the busbars. The frame members are structural foam elements.

In another embodiment, a busbar interconnect for electrically connecting cell terminals of battery cells in a battery pack is provided. The busbar interconnect includes a plurality of busbars arranged in an array having multiple rows and multiple columns of the busbars. Each busbar includes a first mating end for mating with the corresponding cell terminal of the corresponding battery cell and a second mating end for mating with the adjacent corresponding cell terminal of the adjacent corresponding battery cell. The busbars electrically connect the battery cells in the battery pack. The busbar interconnect includes a busbar carrier holding each of busbars in the array. The busbar carrier includes an upper lattice and a lower lattice. The upper lattice includes upper frame members. The lower lattice includes lower frame members. The upper lattice is coupled to the lower lattice with the busbars held therebetween. The upper frame members and the lower frame members are structural foam elements.

In a further embodiment, a battery pack is provided and includes battery cells arranged in an array having multiple rows and multiple columns of the battery cells. Each battery cell includes a first cell terminal and a second cell terminal. The battery pack includes a busbar interconnect for electrically connecting cell terminals of battery cells in a battery pack. The busbar interconnect includes a plurality of busbars and a busbar carrier holding each of the busbars in an array having multiple rows and multiple columns of the busbars. Each busbar includes a first mating end for mating with the first cell terminal of the corresponding battery cell and a second mating end for mating with the second cell terminal of the adjacent corresponding battery cell to electrically connect the battery cells in series. The busbar carrier includes frame members holding relative positions of the busbars. The frame members are structural foam elements.

### BRIEF DESCRIPTION OF THE DRAWINGS

FIG. 1 is a perspective view of a battery pack including a busbar interconnect in accordance with an exemplary embodiment.

FIG. 2 illustrates an array of the busbars in accordance with an exemplary embodiment.

FIG. 3 illustrates the upper lattice of the busbar carrier in accordance with an exemplary embodiment.

FIG. 4 is a cross sectional view of a portion of the upper lattice in accordance with an exemplary embodiment.

FIG. 5 illustrates the lower lattice of the busbar carrier in accordance with an exemplary embodiment.

FIG. 6 is a cross sectional view of a portion of the lower lattice in accordance with an exemplary embodiment.

FIG. 7 is a flow chart showing a method of assembling a battery pack in accordance with an exemplary embodiment.

FIG. 8 is a top view of a portion of the busbar interconnect during a stage of assembly in accordance with an exemplary embodiment.

FIG. 9 is a top view of a portion of the busbar interconnect during assembly in accordance with an exemplary embodiment.

FIG. 10 is a top perspective view of a portion of the busbar interconnect during a stage of assembly showing the upper lattice poised for coupling to the lower lattice and the busbars in accordance with an exemplary embodiment.

FIG. 11 is a top perspective view of a portion of the busbar interconnect during a stage of assembly showing the upper lattice coupled to the lower lattice and the busbars in accordance with an exemplary embodiment.

FIG. 12 is a top view of a portion of the busbar interconnect showing the busbar carrier holding the busbars.

### DETAILED DESCRIPTION OF THE INVENTION

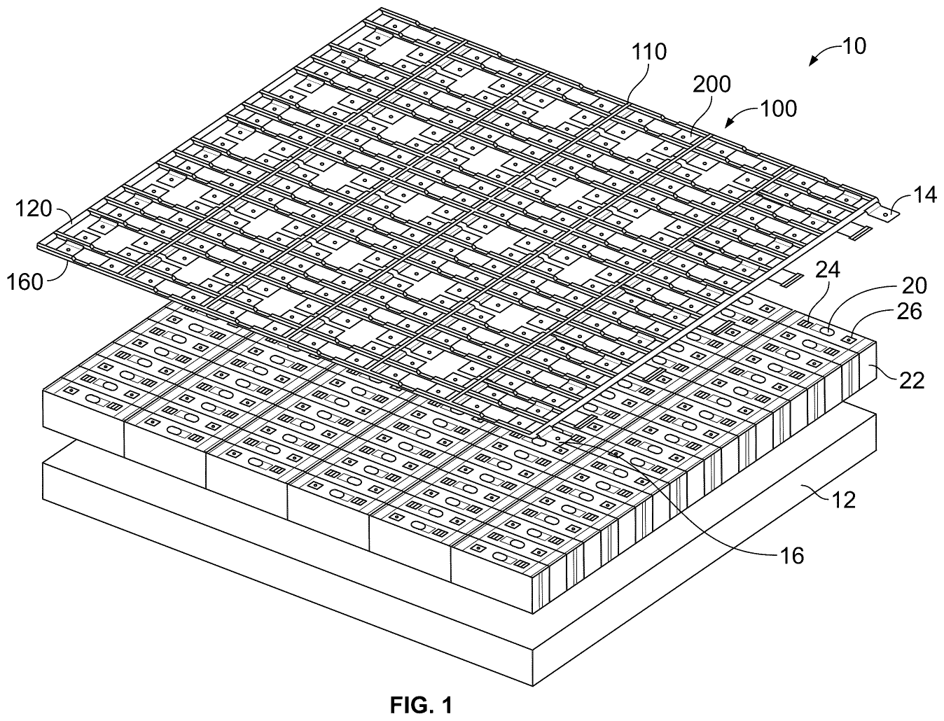

FIG. 1 is a perspective view of a battery pack 10 including a busbar interconnect 100 in accordance with an exemplary embodiment. The battery pack 10 may be a battery pack for a vehicle, such as an electric vehicle. However, the battery pack 10 may be used in other applications in alternative embodiments. In an exemplary embodiment, the battery pack 10 is a high voltage battery pack. For example, the battery pack 10 may be a 400V or 800V battery pack. The busbar interconnect 100 is used to electrically connect an array of battery cells 20 of the battery pack 10. For example, the busbar interconnect 100 may connect the battery cells 20 in series and/or parallel.

The battery cells 20 may be held in a battery pack housing 12. The battery pack 10 includes a positive battery interconnect terminal 14 and a negative battery interconnect terminal 16. The battery interconnect terminals 14, 16 form the main battery terminals of the battery pack 10, such as for connection to a charging system and/or a load, such as an electric motor.

Each battery cell 20 includes a cell housing 22, a first cell terminal 24, and a second cell terminal 26. The battery cell 20 may be a prismatic battery cell in various embodiments. The first and second cell terminals 24, 26 may be cathode and anode terminals. In an exemplary embodiment, the battery cell 20 are rectangular and arranged in a stacked configuration. For example, the battery cells 20 may be stacked in rows and columns of battery cells 20 in the array. The array may have a large surface area, such as greater than two square meters (2 m² or more). Adjacent battery cells 20 in the rows are interconnected by the busbar interconnect 100. Adjacent rows of the battery cells 20 are interconnected by the busbar interconnect 100. For example, end battery cells 20 may be connected row-to-row.

The busbar interconnect 100 includes a busbar carrier 110 holding a plurality of busbars 200. The busbar carrier 110 holds the busbars 200 at relative locations for mating with the cell terminals 24, 26 of the corresponding battery cells 20. The busbars 200 electrically connect adjacent battery cells 20, such as in series and/or in parallel. The busbar carrier 110 integrates all of the busbars 200 into a single unit for mounting to the array of battery cells 20. In an exemplary embodiment, the busbar carrier 110 is a structural foam leadframe that holds the busbars 200. The busbar carrier 110 is manufactured by a structural foam molding process. The structural foam is a cellular structure, such as a micro-cellular structure. In an exemplary embodiment, the structural foam has a low density micro-cellular core and a high density outer skin. The structural foam is rigid and retains its shape to hold the busbars 200 at relative positions for mounting to the battery cells 20. The busbar carrier 110 is made by a low-pressure structural foaming process. The busbar carrier 110 is manufactured from a polymer material, such as a thermoset or a thermoplastic with inert gas, such as nitrogen gas, injected into the mold during the forming process. The gas is co-injected with the resin material in the mold to foam the interior of the plastic. The lattice framework may be made with up to 100% regrind/recycled plastic material for environmental sustainability. A chemical blowing agent may be used to form the structural foam. The structural foam has a high strength-to-weight ratio, such as a higher strength to weight ratio compared to injection molded parts.

In an exemplary embodiment, the busbar carrier 110 is made from two structural foam pieces, such as an upper lattice 120 and a lower lattice 160, which are coupled together to capture the busbars 200 therebetween. For example, the busbars 200 may be stacked between the upper lattice 120 and the lower lattice 160. In an exemplary embodiment, the upper and lower lattices 120, 160 are identical. For example, the upper and lower lattices 120, 160 may be manufactured from the same mold. The upper lattice and the lower lattices 120, 160 may be identical structural foam molded structures inverted 180° on opposite sides of the array of busbars 200. However, the upper and lower lattices 120, 160 may be different and molded from different molds in alternative embodiments. In an exemplary embodiment, the busbar carrier 110 holds all of the busbars 200 for the battery pack 10 to reduce part count for final assembly to the battery pack 10. For example, the single busbar interconnect 100 is assembled to the battery pack 10. The busbar carrier 110 is used to position all of the busbars 200 for electrical connection to the cell terminals 24, 26 of the battery cells 20. The structural foam busbar carrier 110 has excellent stiffness to weight ratio. In an exemplary embodiment, the structural foam busbar carrier 110 acts as a structural member in the battery pack 10 to resist torsion and z-displacement of the components of the battery pack, which improves safety and durability while eliminating the need for other mechanical components.

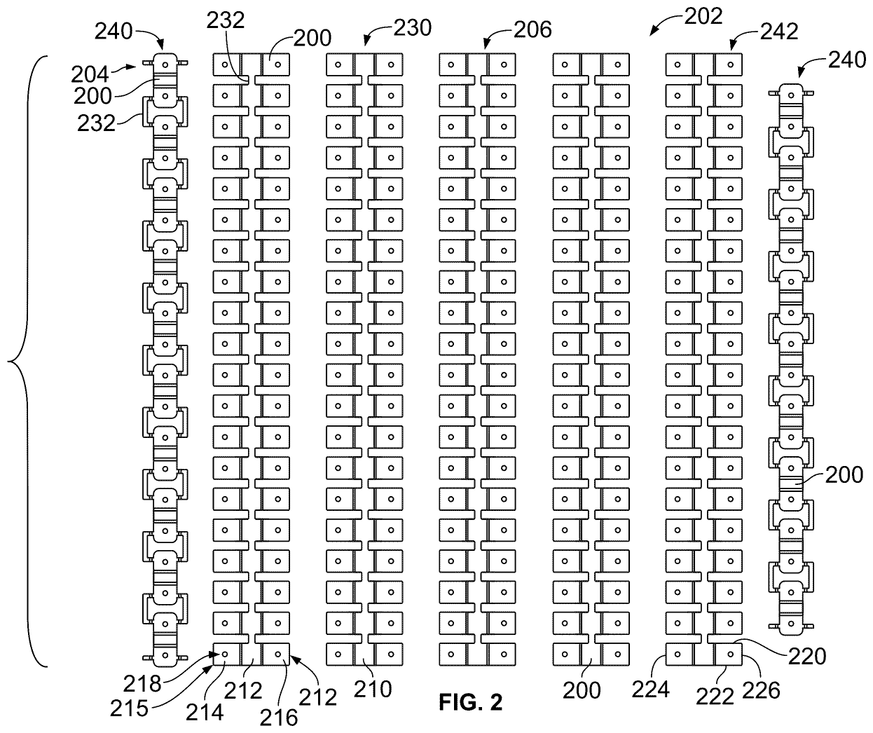

FIG. 2 illustrates an array 202 of the busbars 200 in accordance with an exemplary embodiment. The busbars 200 are arranged in rows 204 and columns 206 in the array 202. The arrangement of the busbars 200 corresponds to the arrangement of the battery cells 20 to connect to the corresponding cell terminals 24, 26.

Each busbar 200 includes a metal plate 210 having a main body 212, a first mating pad 214 at a first mating end 215, and a second mating pad 216 at a second mating end 217. The first mating pad 214 is configured to connect to a cell terminal 24 of one of the battery cells 20. The second mating pad 216 is configured to connect to a cell terminal 26 of an adjacent battery cell 20. The busbar 200 electrically connects the adjacent battery cells 20. The mating pads 214, 216 may include openings 218 therethrough, such as for locating the busbars 200 relative to the cell terminals 24, 26. The openings 218 may be used for a pick and place operation.

In an exemplary embodiment, each busbar 200 is generally rectangular. For example, the busbar 200 includes a first end 220, a second end 222, a first side 224, and a second side 226. The busbar 200 may be elongated, such as having the ends 220, 222 longer than the sides 224, 226. In an exemplary embodiment, the busbar is generally planar. For example, the first and second mating pads 214, 216 may be coplanar. The busbar 200 may include mounting features, such as mounting tabs, posts, brackets, clips, notches, openings, and the like for mounting the busbar 200 to the busbar carrier 110.

In an exemplary embodiment, the busbars 200 are arranged in busbar strips 230. For example, a plurality of the busbars 200 may be stamped from a common sheet of material and arranged in strip format. In the illustrated embodiment, seven busbar strips 230 are provided. Greater or fewer busbar strips 230 may be provided in alternative embodiments. In the illustrated embodiment, twenty busbars 200 are provided in the busbar strips 230. Greater or fewer busbars 200 may be provided in each busbar strip 230 in alternative embodiments. Different busbar strips 230 may have different numbers of busbars 200. In an exemplary embodiment, connecting links 232 connect the busbars 200 in the busbar strips 230. The connecting links 232 mechanically fix the busbars 200 relative to each other, such as controlling a spacing between the busbars 200. The connecting links 232 are thin strips. Optionally, a single connecting link 232 may be located between the adjacent busbars 200. However, multiple connecting links 232 may extend between the adjacent busbars 200 in alternative embodiments. The connecting links 232 are sacrificial and configured to be removed, such as by a stamping, punching, or cutting process to singulate and electrically isolate the busbars 200 from each other for connection to different battery cells 20.

In the illustrated embodiment, the connecting links 232 extend between the main bodies 212 of the adjacent busbars 200 in the busbar strips 230. The connecting links 232 may additionally or alternatively extend between the mating pads 214, 216 at the sides 224, 226 of the adjacent busbars 200. In the illustrated embodiment, the busbar strips 230 are arranged in column. For example, the connecting links 232 connect together all of the busbars 200 within each column 206. In alternative embodiments, the busbar strips 230 may be arranged in rows. For example, the connecting links 232 may connect together all of the busbars 200 within each row 204. In other embodiments, the connecting links 232 may be arranged both in column and in row. For example, all of the busbars 200 in the array 202 may be stamped from a single sheet.

In an exemplary embodiment, the busbars 200 include outer busbars 240 and inner busbars 242. The outer busbars 240 are arranged along the opposite sides of the array 202 (for example, right side and left side). The outer busbars 240 are used to connect between two different rows of the battery cells 20. The inner busbars 242 extend between the outer busbars 240. The inner busbars 242 are used to connect the adjacent battery cells 20 within the same column. The outer busbars 240 are oriented perpendicular to the inner busbars 242. For example, the inner busbars 242 are oriented longitudinally and the outer busbars 240 are oriented laterally. Other orientations are possible in alternative embodiments. In the illustrated embodiment, five inner busbar strips 242 are arranged between the outer busbar strips 240. Greater or fewer numbers of the inner busbars 242 may be provided in alternative embodiments. In the illustrated embodiment, the connecting links 232 connecting the outer busbars 240 are different than the connecting links 232 connecting the inner busbars 242. For example, the inner connecting links extend between the main bodies 212, whereas the outer connecting links extend between the mating pads 214, 216. In the illustrated embodiment, two outer connecting links are provided between the adjacent outer busbars 240 as opposed to single inner connecting links between the adjacent inner busbars 242.

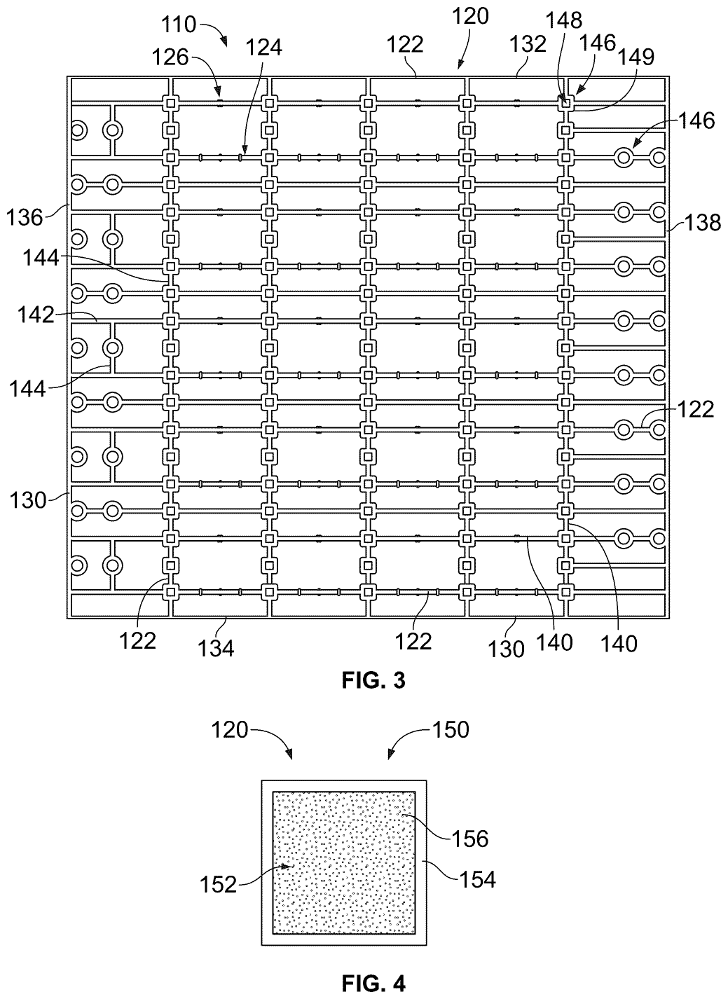

FIG. 3 illustrates the upper lattice 120 of the busbar carrier 110 in accordance with an exemplary embodiment. FIG. 4 is a cross sectional view of a portion of the upper lattice 120 in accordance with an exemplary embodiment.

The upper lattice 120 includes frame members 122 configured to be coupled to the busbars 200 to hold relative positions of the busbars 200. The frame members 122 are structural foam elements 150. The frame members 122 include outer frame members 130 surrounding a perimeter of the upper lattice 120 and inner frame members 140 spanning across an interior of the upper lattice 120 to interface with the busbars 200. In the illustrated embodiment, the outer frame members 130 completely enclose the perimeter. The outer frame members 130 include a first end member 132, a second end member 134, a first side member 136, and a second side member 138. The side members 136, 138 extend between the end members 132, 134. Optionally, the upper lattice 120 is elongated with the side members 136, 138 being longer than the end members 132, 134 in the longitudinal direction. The end members 132, 134 may be perpendicular to the side members 136, 138 in the lateral direction. Greater or fewer members may be provided in alternative embodiments to change the shape and the number of sides of the outer perimeter of the upper lattice 120.

The inner frame members 140 extend between the outer frame members 130. For example, the inner frame members 140 include longitudinal elements 142 and lateral elements 144. The longitudinal elements 142 extend longitudinally across the upper lattice 120 between the opposite end members 132, 134. The longitudinal elements 142 and/or the lateral elements 144 may be used to support portions of the busbars 200. The longitudinal elements 142 may be oriented generally parallel to the side member 136, 138. The lateral elements 144 extend laterally across the upper lattice 120 between the opposite side members 136, 138. The lateral elements 144 may be oriented generally parallel to the end members 132, 134. The lateral elements 144 interconnect the longitudinal elements 142, such as to provide support to the longitudinal elements 142, and vice versa. In an exemplary embodiment, the inner frame members 140 are formed integral with the outer frame members 130. For example, the inner frame members 140 are formed along with the outer frame members 130 during a structural foam molding process. The upper lattice 120 forms a unitary, monolithic structural foam structure.

In an exemplary embodiment, the upper lattice 120 includes a plurality of nodes 146. The nodes 146 may be provided at the intersections of the longitudinal elements 142 and the lateral elements 144. The nodes 146 may be provided at the locations of the busbars 200. The nodes 146 may be used to support portions of the busbars 200. In an exemplary embodiment, the nodes 146 include openings 148. Each node 146 includes a ring 149 surrounding the opening 148. The opening 148 is configured to be aligned with the corresponding connecting link 232. In an exemplary embodiment, the connecting link 232 may be removed by punching or cutting the connecting link 232 through the opening 148. In other embodiments, the connecting link 232 may be located outside of the node 146 and the punching or cutting may occur outside of the node 146, such as along the outer surface of the frame member 122 or even remote from the frame member 122.

Each frame member 122 includes the structural foam element 150. The structural foam element 150 is manufactured by a structural foaming process. The structural foam element 150 of the frame member 122 has a honeycomb-like microporous interior core structure. For example, each frame member 122 includes a foam core 152 (FIG. 4) and a skin 154 surrounding the foam core 152. The skin 154 has a higher density than the foam core 152. The foam core 152 include pockets or cells 156, which may be filled with air. The skin 154 may be solid, such as being devoid of air pockets. The skin 154 may be relatively thin, compared to the foam core 152.

In an exemplary embodiment, the upper lattice 120 includes upper alignment features 124 used to align the upper lattice 120 relative to the lower lattice 160. The upper alignment features 124 may include tabs, posts, protrusions, grooves, slots, openings, or other types of alignment features. The upper alignment features 124 may be complimentary to corresponding alignment features of the lower lattice 160 to position the upper lattice 120 relative to the lower lattice 160.

In an exemplary embodiment, the upper lattice 120 includes upper securing features 126 used to secure the upper lattice 120 to the lower lattice 160. The upper securing features 126 may include tabs, bosses, latches, clips, fasteners, or other types of securing features. The upper securing features 126 may be complimentary to corresponding securing features of the lower lattice 160 to secure the upper lattice 120 to the lower lattice 160.

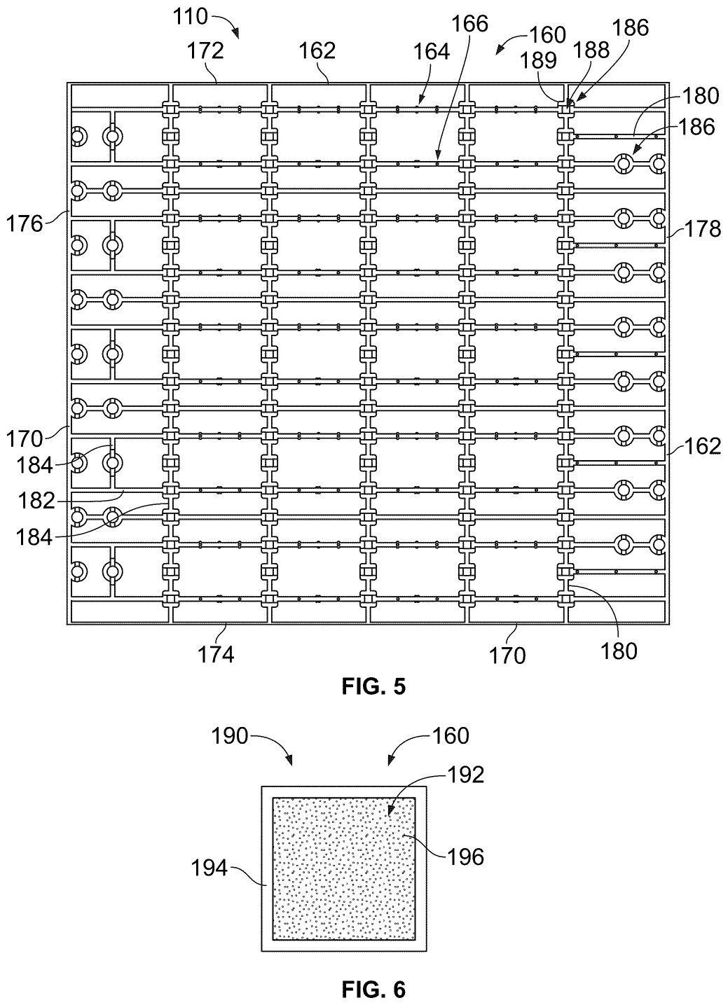

FIG. 5 illustrates the lower lattice 160 of the busbar carrier 110 in accordance with an exemplary embodiment. FIG. 6 is a cross sectional view of a portion of the lower lattice 160 in accordance with an exemplary embodiment.

The lower lattice 160 includes frame members 162 configured to be coupled to the busbars 200 to hold relative positions of the busbars 200. The frame members 162 are structural foam elements 190. The frame members 162 include outer frame members 170 surrounding a perimeter of the lower lattice 160 and inner frame members 180 spanning across an interior of the lower lattice 160 to interface with the busbars 200. In the illustrated embodiment, the outer frame members 170 completely enclose the perimeter. The outer frame members 170 include a first end member 172, a second end member 174, a first side member 176, and a second side member 178. The side members 176, 178 extend between the end members 172, 174. Optionally, the lower lattice 160 is elongated with the side members 176, 178 being longer than the end members 172, 174 in the longitudinal direction. The end members 172, 174 may be perpendicular to the side members 176, 178 in the lateral direction. Greater or fewer members may be provided in alternative embodiments to change the shape and the number of sides of the outer perimeter of the lower lattice 160.

The inner frame members 180 extend between the outer frame members 170. For example, the inner frame members 180 include longitudinal elements 182 and lateral elements 184. The longitudinal elements 182 extend longitudinally across the lower lattice 160 between the opposite end members 172, 174. The longitudinal elements 182 and/or the lateral elements 184 may be used to support portions of the busbars 200. The longitudinal elements 182 may be oriented generally parallel to the side member 176, 178. The lateral elements 184 extend laterally across the lower lattice 160 between the opposite side members 176, 178. The lateral elements 184 may be oriented generally parallel to the end members 172, 174. The lateral elements 184 interconnect the longitudinal elements 182, such as to provide support to the longitudinal elements 182, and vice versa. In an exemplary embodiment, the inner frame members 180 are formed integral with the outer frame members 170. For example, the inner frame members 180 are formed along with the outer frame members 170 during a structural foam molding process. The lower lattice 160 forms a unitary, monolithic structural foam structure.

In an exemplary embodiment, the lower lattice 160 includes a plurality of nodes 186. The nodes 186 may be provided at the intersections of the longitudinal elements 182 and the lateral elements 184. The nodes 186 may be provided at the locations of the busbars 200. The nodes 186 may be used to support portions of the busbars 200. In an exemplary embodiment, the nodes 186 include openings 188. Each node 186 includes a ring 189 surrounding the opening 188. The opening 188 is configured to be aligned with the corresponding connecting link 232. In an exemplary embodiment, the connecting link 232 may be removed by punching or cutting the connecting link 232 through the opening 188. In other embodiments, the connecting link 232 may be located outside of the node 186 and the punching or cutting may occur outside of the node 186, such as along the outer surface of the frame member 162 or even remote from the frame member 162.

Each frame member 162 includes the structural foam element 190. The structural foam element 190 is manufactured by a structural foaming process. The structural foam element 190 of the frame member 162 has a honeycomb-like porous interior core structure. For example, each frame member 162 includes a foam core 192 (FIG. 6) and a skin 194 surrounding the foam core 192. The skin 194 has a higher density than the foam core 192. The foam core 192 includes pockets or cells 196, which may be filled with air. The skin 194 may be solid, such as being devoid of air pockets. The skin 194 may be relatively thin, compared to the foam core 192.

In an exemplary embodiment, the lower lattice 160 includes lower alignment features 166 used to align the lower lattice 160 relative to the upper lattice 120. The lower alignment features 166 may include tabs, posts, protrusions, grooves, slots, openings, or other types of alignment features. The lower alignment features 166 may be complimentary to the upper alignment features 124 of the upper lattice 120 to position the lower lattice 160 relative to the upper lattice 120.

In an exemplary embodiment, the lower lattice 160 includes lower securing features 164 used to secure the lower lattice 160 to the upper lattice 120. The lower securing features 164 may include tabs, bosses, latches, clips, fasteners, or other types of securing features. The lower securing features 164 may be complimentary to the corresponding upper securing features 126 of the upper lattice 120 to secure the lower lattice 160 to the upper lattice 120.

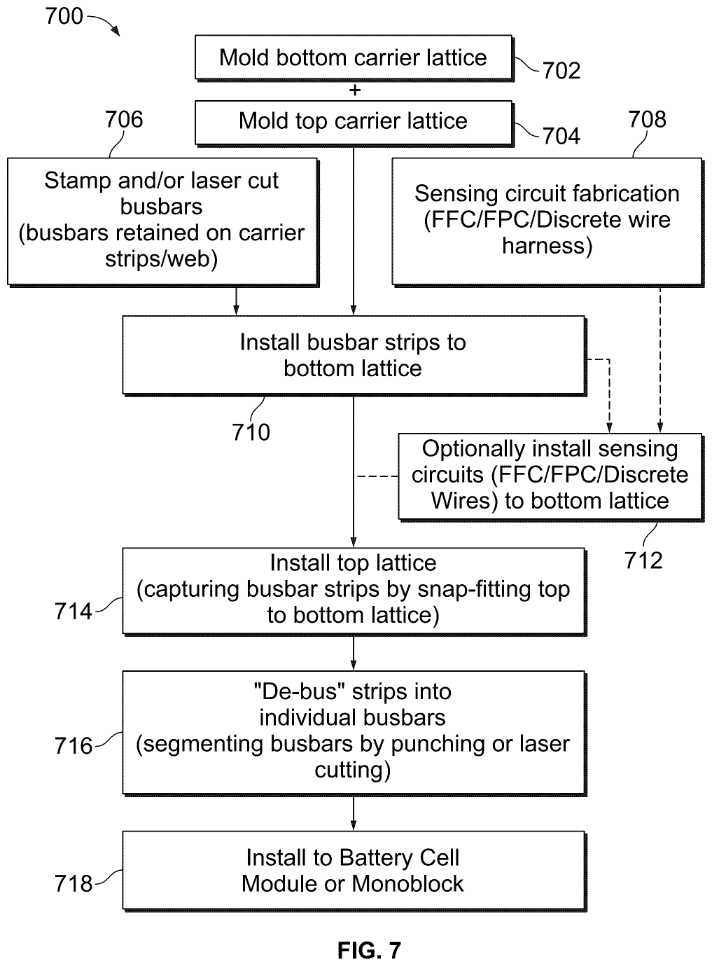

FIG. 7 is a flow chart 700 showing a method of assembling a battery pack in accordance with an exemplary embodiment. At 702, the method includes the step of structural foam molding a lower lattice. At 704, the method includes the step of structural foam molding an upper lattice. The foam molding steps may be performed sequentially or simultaneously, such as with a two-cavity mold. In various embodiments, the lower lattice and the upper lattice may be identical structures, so the same foam molding step may be used to form either of the lattice frameworks, such as using the same mold tools. For example, the upper lattice and the lower lattice may be identical structural foam molded structures inverted 180° on opposite sides of the array of busbars. The structural foam molding processes include molding frame members, such as into a lattice framework including longitudinal members and lateral members. The structural foam molding process includes forming a skin surrounding a foam core. The structural foam molding process includes adding inert gas, such as nitrogen, into a mold with thermoplastic or thermoset material. The structural foam molding process may include adding a chemical blowing agent into the mold with the thermoplastic or thermoset material.

At 706, the method includes forming busbars. The busbars may be formed by a stamping or laser cutting process. In an exemplary embodiment, the busbars are formed as busbar strips with connecting links between the various busbars. The connecting links maintain relative positions of the busbars.

At 708, the method includes the optional step of forming a sensing harness. The sensing harness includes a plurality of sensors, such as temperature sensors, voltage sensors, or other types of sensors. The sensors are connected by circuits. The circuits may be flat flexible circuits, a flexible printed circuit, or a wire harness.

At 710, the method includes installing the busbars on the lower lattice. The busbar strips may be inset into the lower lattice. By assembling the busbars in strip form, the part count is greatly reduced during the assembly process, leading to faster cycle times and easier handling. The frame members of the lower lattice support the busbars. In an exemplary embodiment, the connecting links are aligned with openings in nodes of the framework of the lower lattice for later access and removal.

At 712, the method includes the optional step of installing the sensing harness on the busbars. The sensors may be coupled to the corresponding busbars. Optionally, every busbar may have a corresponding sensor associated therewith. The sensor may be soldered, welded, or otherwise mechanically joined or fastened to the busbar.

At 714, the method includes installing the upper lattice on the busbars and the lower lattice. The upper lattice is aligned with the lower lattice by alignment features. The busbars, and possibly the optional sensing circuit components, are captured between the upper lattice and the lower lattice. Optionally, nodes of the upper lattice may be aligned with the connecting links, such as aligning openings in the nodes with the connecting links for later removal. The upper lattice may be secured to the lower lattice, such as using securing features.

At 716, the method includes debussing the busbars by removing the connecting links. The connecting links may be removed by a stamping or cutting process. The connecting links may be removed by laser cutting the connecting links. The connecting links are removed to singulate the busbars from each other and from the busbar strip. The connecting links are removed to electrically isolate the busbars from each other.

At 718, the method includes installing the busbar interconnect on the battery cells of the battery pack. For example, the busbar carrier (upper and lower lattice) is used to position all of the busbars at locations aligned with the respective cell terminals of the battery cells to electrically connect the busbars to the battery cells. For example, the busbar carrier holds the positions of the busbars for laser welding to the cell terminals.

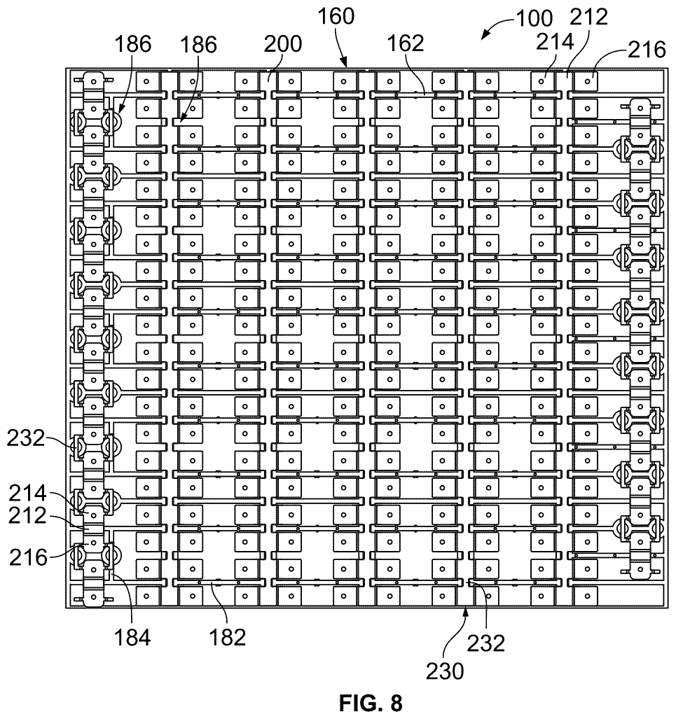

FIG. 8 is a top view of a portion of the busbar interconnect 100 during a stage of assembly. FIG. 8 shows the busbars 200 installed on the lower lattice 160. In an exemplary embodiment, the busbars 200 are installed on the lower lattice 160 as busbar strips 230 with the connecting links 232 holding positions of the busbars 200 relative to each other within the busbar strips 230. The frame members 162 of the lower lattice 160 support the busbars 200. For example, the busbars 200 are supported by the longitudinal elements 182 and the lateral elements 184. The frame members 162 may be located below the main body 212, and/or the first mating pad 214, and/or the second mating pad 216, and/or the connecting links 232 of each busbar 200. In an exemplary embodiment, the connecting links 232 are arranged at the nodes 186.

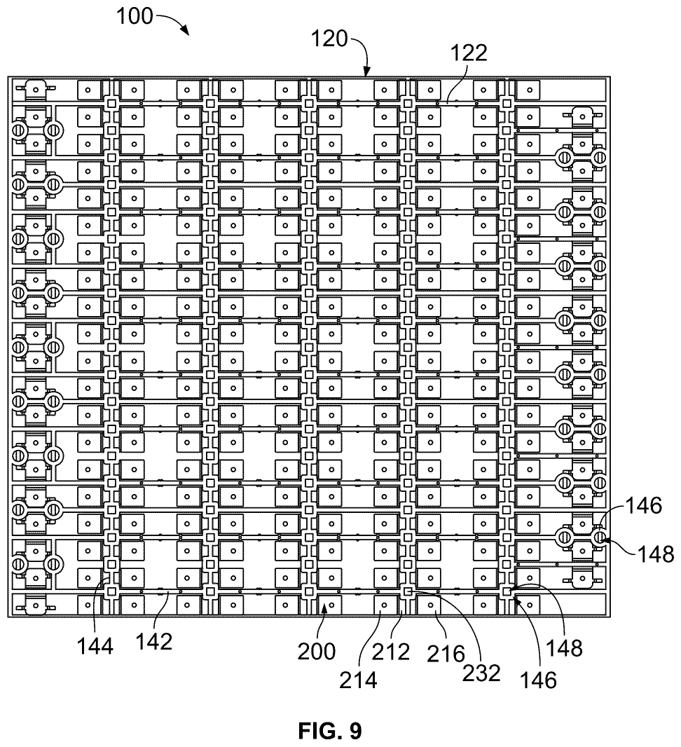

FIG. 9 is a top view of a portion of the busbar interconnect 100 during assembly. FIG. 9 shows the upper lattice 120 coupled to the lower lattice 160 and the busbars 200. The busbars 200 are captured between the upper lattice 120 and the lower lattice 160. For example, the frame members 122 of the upper lattice 120 support the busbars 200. The frame members 122 may be aligned with the frame members 162 to capture the busbars 200 therebetween. The busbars 200 may be supported by the longitudinal elements 142 and/or the lateral elements 144. For example, the frame members 122 may support the main body 212, and/or the first mating pad 214, and/or the second mating pad 216, and/or the connecting links 232 of each busbar 200. In an exemplary embodiment, the connecting links 232 are arranged at the nodes 146. For example, the connecting links 232 may be exposed in the openings 148 of the nodes 146, such as for later removal.

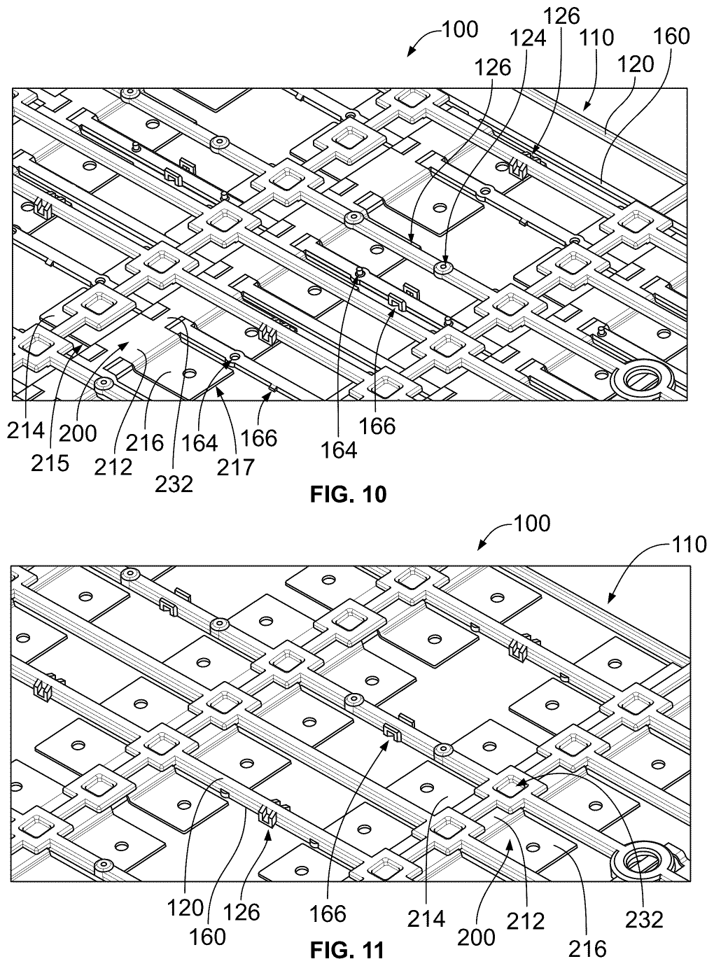

FIG. 10 is a top perspective view of a portion of the busbar interconnect 100 during a stage of assembly showing the upper lattice 120 poised for coupling to the lower lattice 160 and the busbars 200. FIG. 11 is a top perspective view of a portion of the busbar interconnect 100 during a stage of assembly showing the upper lattice 120 coupled to the lower lattice 160 and the busbars 200. The upper lattice 120 and the lower lattice 160 form a rigid busbar carrier 110 for supporting each of the busbars 200 at predetermined locations for termination to the cell terminals 24, 26 of the battery cells 20. In an exemplary embodiment, the mating pads 214, 216 of each busbar 200 are stepped downward relative to the main body 212 to position the mating interfaces at the mating ends 215, 217 at the bottom of the busbar interconnect 100. For example, the mating ends 215, 217 may be located coplanar with the bottom surface of the lower lattice 160 for connection of the busbars 200 to the cell terminals 24, 26 of the battery cells 20.

During assembly, the alignment features 124 of the upper lattice 120 are aligned with the alignment features 164 of the lower lattice 160. The alignment features 124 interface with the alignment features 164 to properly orient the upper lattice 120 relative to the lower lattice 160. In an exemplary embodiment, the alignment features 124 include alignment posts and/or alignment openings and the alignment features 164 include complementary alignment posts and/or alignment openings. For example, the alignment posts of the upper lattice 120 are received in the alignment openings of the lower lattice 160. Similarly, the alignment posts of the lower lattice 160 are received in the alignment openings of the upper lattice 120. Other types of alignment features may be used in alternative embodiments.

During assembly, the securing features 126 of the upper lattice 120 are aligned with and coupled to the securing features 166 of the lower lattice 160. The securing features 126 interface with the securing features 166 to secure the upper lattice 120 to the lower lattice 160. In an exemplary embodiment, the securing features 126 include securing bosses and/or securing latches and the securing features 166 include complementary securing bosses and/or securing latches. For example, the securing latches of the upper lattice 120 are latchably coupled to the securing bosses of the lower lattice 160. Similarly, the securing latches of the lower lattice 160 are latchably coupled to the securing bosses of the upper lattice 120. Other types of securing features may be used in alternative embodiments.

After the busbar carrier 110 is assembled, the connecting strips 232 between the busbars 200 may be removed. For example, the connecting strips 232 may be stamped, punched, or cut and removed from the busbars 200. In various embodiments, the connecting strips 232 may be removed by a laser cutting process. Removal of the connecting strips 232 electrically isolates the busbars 200 from each other. The busbar carrier 110 securely holds the positions of the busbars 200 relative to each other after the connecting strips 232 are removed.

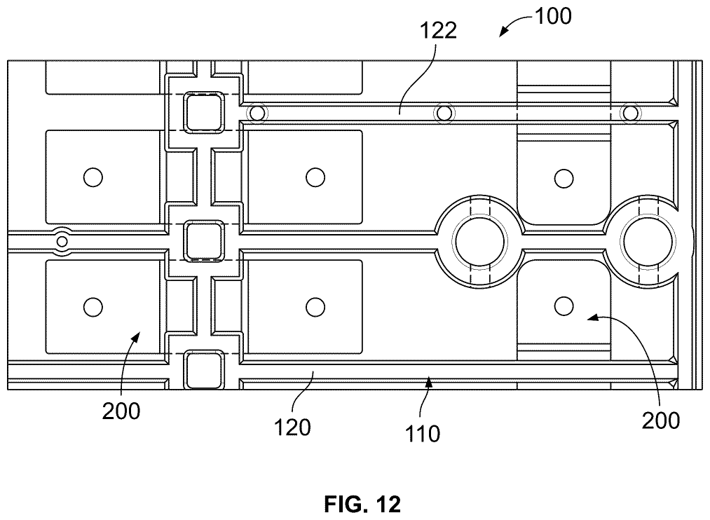

FIG. 12 is a top view of a portion of the busbar interconnect 100 showing the busbar carrier 110 holding the busbars 200. The connecting strips 232 (FIG. 10) are removed in FIG. 12. The busbars 200 are held by the frame members 122, 162 of the upper lattice 120 and the lower lattice 160.

The busbar interconnect 100 provides a large format battery cell interconnect that is configured to be mounted to the battery pack 10 (for example, each of the battery cells 20) as a single unit. The busbar carrier 110 holds all of the busbars 200 at proper locations for termination to the cell terminals 24, 26 of each of the battery cells 20 of the battery pack 10. By holding all of the busbars 200 for assembly to all of the battery cells 20 of the battery pack 10, assembly processes may be eliminated, such as with conventional battery systems where each of the busbars are assembled to the battery cells individually or in multiple strips with multiple assembly steps. The busbar interconnect 100 reduces the overall part number count and reduces the number of handled components during assembly of the battery pack 10. The busbar carrier 110 may have a large format and surface area. For example, the structural foam process to manufacture the lattice framework for the busbar carrier 110 of the large footprint for the busbar carrier 110, particularly compared to injection molded parts. The busbar carrier 110 has a higher strength to weight ratio compared to comparable injection molded parts. The lattice framework support the busbar carrier 110 may be manufactured in a low-pressure, structural foam molding process, allowing use of lower cost molds (for example, aluminum molds compared to high-strength steel molds). The structural foam material of the lattice framework for the busbar carrier 110 is dimensionally stable and does not tend to warp making assembly and termination to the battery cells more simple, quicker, and lower cost compared to conventional assembly processes. The structural foam material is more sustainable to the environment compared to conventional injection molded plastic parts. For example, the structural foam material uses less plastic and may use recycled material.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. A busbar interconnect for electrically connecting cell terminals of battery cells in a battery pack, the busbar interconnect comprising:
a plurality of busbars arranged in an array having multiple rows and multiple columns of the busbars, each busbar including a first mating end for mating with the corresponding cell terminal of the corresponding battery cell and a second mating end for mating with the adjacent cell terminal of the adjacent corresponding battery cell, the busbars electrically connecting the battery cells in the battery pack; and
a busbar carrier holding each of busbars in the array, the busbar carrier including frame members holding relative positions of the busbars, the frame members being structural foam elements.

2. The busbar interconnect of claim 1, wherein the frame members have a honeycomb-like porous interior core structure.

3. The busbar interconnect of claim 1, wherein each frame member includes a foam core and a solid skin surrounding the foam core.

4. The busbar interconnect of claim 3, wherein the skin has a higher density than the foam core.

5. The busbar interconnect of claim 1, wherein the frame members have a higher strength to weight ratio compared to comparable injection molded parts.

6. The busbar interconnect of claim 1, wherein the frame members include outer frame members surrounding a perimeter of the busbar carrier and inner frame members spanning across an interior of the busbar carrier to interface with the busbars.

7. The busbar interconnect of claim 6, wherein the inner frame members including longitudinal elements and lateral elements interconnecting the longitudinal elements.

8. The busbar interconnect of claim 1, wherein the frame members include nodes adjacent the busbars, the nodes supporting the busbars.

9. The busbar interconnect of claim 8, wherein the busbars are stamped and formed in busbar strips with connecting links stamped with the busbars and extending between the busbars to support relative positions of the busbars, the nodes located at the connecting links, wherein the connecting links are removed after the busbars are held by the busbar carrier to electrically separate the busbars from each other.

10. The busbar interconnect of claim 9, wherein each node includes a ring surrounding an opening, the opening aligned with the corresponding connecting link to allow removal of the connecting link through the opening.

11. The busbar interconnect of claim 1, wherein the frame members include upper frame members and lower frame members, the upper frame members molded to form an upper lattice, the lower frame members molded to form a lower lattice, the upper lattice coupled to the lower lattice to form the busbar carrier, the busbars captured between the upper lattice and the lower lattice.

12. The busbar interconnect of claim 11, wherein the upper lattice and the lower lattice are identical structural foam molded structures inverted 180° on opposite sides of the array of busbars.

13. The busbar interconnect of claim 11, wherein the upper lattice includes upper alignment features, the lower lattice including lower alignment features, the upper alignment features interfacing with the lower alignment features to position the upper lattice relative to the lower lattice.

14. The busbar interconnect of claim 1, further comprising a sensing harness having sensors coupled to the busbars, the busbar carrier supporting the sensing harness.

15. A busbar interconnect for electrically connecting cell terminals of battery cells in a battery pack, the busbar interconnect comprising:
a plurality of busbars arranged in an array having multiple rows and multiple columns of the busbars, each busbar including a first mating end for mating with the corresponding cell terminal of the corresponding battery cell and a second mating end for mating with the adjacent corresponding cell terminal of the adjacent corresponding battery cell, the busbars electrically connecting the battery cells in the battery pack; and
a busbar carrier holding each of busbars in the array, the busbar carrier including an upper lattice and a lower lattice, the upper lattice including upper frame members, the lower lattice including lower frame members, the upper lattice being coupled to the lower lattice with the busbars held therebetween, the upper frame members and the lower frame members being structural foam elements.

16. A battery pack comprising:
battery cells arranged in an array having multiple rows and multiple columns of the battery cells, each battery cell including a first cell terminal and a second cell terminal; and
a busbar interconnect for electrically connecting cell terminals of battery cells in a battery pack, the busbar interconnect including a plurality of busbars and a busbar carrier holding each of the busbars in an array having multiple rows and multiple columns of the busbars, each busbar including a first mating end for mating with the first cell terminal of the corresponding battery cell and a second mating end for mating with the second cell terminal of the adjacent corresponding battery cell to electrically connect the battery cells in series, the busbar carrier including frame members holding relative positions of the busbars, the frame members being structural foam elements.

17. The battery pack of claim 16, wherein the frame members include outer frame members surrounding a perimeter of the busbar carrier and inner frame members spanning across an interior of the busbar carrier to interface with the busbars.

18. The battery pack of claim 16, wherein the busbars are stamped and formed in busbar strips with connecting links stamped with the busbars and extending between the busbars to support relative positions of the busbars, the frame members including nodes adjacent the busbars supporting the busbars, the nodes located at the connecting links, wherein the connecting links are removed after the busbars are held by the busbar carrier to electrically separate the busbars from each other.

19. The battery pack of claim 16, wherein the frame members include upper frame members and lower frame members, the upper frame members molded to form an upper lattice, the lower frame members molded to form a lower lattice, the upper lattice coupled to the lower lattice to form the busbar carrier, the busbars captured between the upper lattice and the lower lattice.

20. The battery pack of claim 16, wherein the upper lattice and the lower lattice are identical structural foam molded structures inverted 180° on opposite sides of the array of busbars.
